(19) United States
(12) Patent Application Publication
(10) Pub. No.: US 2010/0318937 A1
(43) Pub. Date: Dec. 16, 2010

(54) METHOD AND APPARATUS FOR INFORMATION REPRODUCTION

(75) Inventors: Fujiko Nobe, Kumagaya-shi (JP); Takashi Nakamura, Musashino-shi (JP); Hideo Kataoka, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/813,416

(22) Filed: Jun. 10, 2010

(30) Foreign Application Priority Data
Jun. 10, 2009 (JP) 2009-139594

(51) Int. Cl. G06F 3/048

(52) U.S. Cl. 715/799; 715/803

(57) ABSTRACT

According to one embodiment, directed to an information reproduction apparatus and an information reproduction method, which extracts the type of a reproducible medium and the type of a reproducible content, displays the extracted medium type in a first display region, displays the extracted content type in a second display region, and emphasizes and displays the display region which has accepted a selecting instruction with respect to the display region which is not selected in the first and second display regions, whereby the visibility of a file improves, and easy selection is enabled.

### CROSS-REFERENCE TO RELATED APPLICATIONS

This application is based upon and claims the benefit of priority from Japanese Patent Application No. 2009-139594 filed Jun. 10, 2009; the entire contents of which are incorporated herein by reference.

### FIELD

Embodiments described herein relates generally to an information reproduction apparatus which reproduces content such as moving pictures, still pictures, music and voice, and an information reproduction method.

### BACKGROUND

Content (referred to as programs or titles sometimes) such as video data (moving picture files with voice or music files), audio data (voice files) and still pictures are supplied to an audience (users) by using, as media, for example, optical disks conforming to the Digital Versatile Disk (DVD) standard, semiconductor storage such as Secure Digital (SD) cards, large-capacity storage such as a flash drives and the like. Examples of content suppliers include distribution companies operating servers on a network (LAN) and broadcasting companies transmitting electromagnetic signals.

To decrease the volume of data involved (amount of memory used), the content is compressed by any of various systems such as Moving Picture Experts Group (MPEG)-2, MPEG-4 (H.264-AVC), Windows (registered trademark) Media Audio (WMA), MPEG audio layer-3 (MP3) and Joint Photographic Experts Group (JPEG).

As described above, with the diversification of the media and compression systems used for the provision of content, an information reproduction apparatus which can reproduce content compressed and recorded in different media by an arbitrary compression system has already been put into practical use. However, although the operability of such an apparatus has been improved by a graphical user interface (GUI), considerable improvements in the GUI and its visibility have been demanded.

Japanese Patent Application Publication (KOKAI) No. 2005-11107 discloses a display apparatus having hierarchical screen switching tab switches which switch and display a hierarchical screen constituted of two or more hierarchies.

In the above document, two or more groups of tab switches are arranged in a perpendicular direction while avoiding the same axis line. This arrangement is useful for a case where a screen display (display screen) has a comparatively large size, and is directly touched by user's fingers to switch the tab switches.

However, it is known that when the display of a GUI screen, for example, one of touch panel type button displays (corresponding to the tab switches described in the above document) is selected by a remote control terminal (remote controller) or the like to input a control instruction, the operation of the remote control terminal for inputting the control instruction easily becomes complicated. In particular, when such a control instruction as to select two or more GUI screens displayed at comparatively remote positions alternately (or in order) is necessary, the number of requested operation times of the remote control terminal increases. This is a factor which causes an input error (input of a control instruction different from the necessary control instruction).

### BRIEF DESCRIPTION OF THE DRAWINGS

FIG. 1 is an exemplary diagram showing an example of an information reproduction apparatus (player apparatus) according to an embodiment;

FIG. 2 is an exemplary diagram showing an example of a display output (‘a start screen’) output by the information reproduction apparatus shown in FIG. 1 according to the embodiment;

FIG. 3 is an exemplary diagram showing an example of a screen display which accepts the input of a control instruction which can independently select media and content in a specific function selected in the ‘start screen’ explained with reference to FIG. 2, for example, a media player function according to the embodiment;

FIG. 4 is an exemplary diagram showing an example of a state in which the type of medium where the content to be reproduced by a user is stored has been selected via a “first tab (media type display region)” in the media player function explained with reference to FIG. 3 according to the embodiment;

FIG. 5 is an exemplary diagram showing an example of a state in which the type of the content to be reproduced by the user has been selected via a “second tab (content type display region)” in the media player function explained with reference to FIG. 3 according to the embodiment;

FIG. 6 is an exemplary flowchart showing an example for explaining, in a software manner, a function of changing a display system of the first and second tabs explained with reference to FIGS. 4 and 5 according to the embodiment;

FIG. 7 is an exemplary flowchart showing another example for explaining, in a software manner, a method for changing the display explained with reference to FIG. 6 according to the embodiment;

FIG. 8 is an exemplary flowchart showing an example of a display screen having a different direction in the enlargement of the tab display (change of display of selected tab) explained with reference to FIG. 4 according to the embodiment; and

FIG. 9 is an exemplary diagram showing an example of a display screen having a different direction in the enlargement of the tab display (change of display of selected tab) explained with reference to FIG. 5 according to the embodiment.

### DETAILED DESCRIPTION

In general, according to one embodiment, an information reproduction apparatus comprising: a first display region configured to which displays the types of media; a second display region configured to display the types of content stored in the media; and a display control module configured to the display with emphasizing all of selected one of the first display region and the second display region, when the selection is made.

Embodiments will now be described hereinafter in detail with reference to the accompanying drawings.

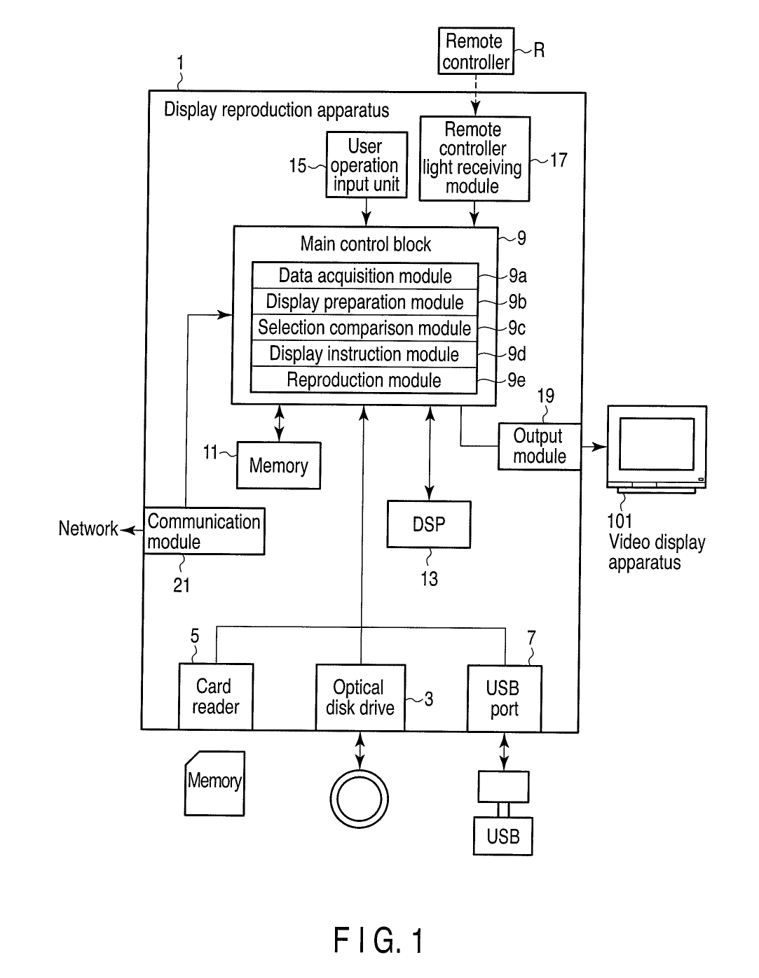

FIG. 1 shows an example of an information reproduction apparatus (player apparatus) to which the embodiment is applied. In addition, the systems described herein can be implemented as software applications, hardware and/or software modules, or components on one or more computers, such as servers. While the various modules are illustrated separately, they may share some or all of the same underlying logic or code.

An information reproduction apparatus 1 has an optical disk drive unit 3 for reproducing content (referred as to programs or titles sometimes) such as video, that is, video data (moving picture files with voice or music files), audio data (voice files) and still pictures supplied by using, as media, for example, an optical disk conforming to the Digital Versatile Disk (DVD) standard, semiconductor storage such as a Secure Digital (SD) card, large-capacity storage such as a flash drive and the like; a card reader 5; and a USB input port 7.

The optical disk drive unit 3 can reproduce the optical disks of the DVD standard and a compact disk (CD) standard. As to a file type (content type) supported by the unit, examples of the type for the moving picture include Moving Picture Experts Group (MPEG)-2 and MPEG-4 (H.264-AVC), examples of the type for the audio include Windows Media Audio (WMA), MPEG audio layer-3 (MP3) and Musical Instrument Digital Interface (MIDI) data, and examples of the type for the still picture include Joint Photographic Experts Group (JPEG).

The card reader 5 and the USB input port 7 can similarly reproduce the moving picture of, for example, MPEG-2, MPEG-4 (H.264-AVC) or the like, the audio of, for example, WMA, MP3, MIDI data or the like, and the still picture of JPEG or the like.

A main control block 9 reproduces the content supplied from the media via the optical disk drive unit 3, the card reader 5 or the USB input port 7 by a memory unit (work memory) 11. It is to be noted that the memory unit 11 is a rewritable type memory typified by, for example, a synchronous dynamic random access memory (SDRAM) or the like. Moreover, an application (program/protocol) or the like used to reproduce the content is stored (memorized) in a predetermined region of the memory unit 11, but when a new application is supplied, the application can be stored in a vacant region by a plug-in function.

The main control block 9 includes a data acquisition unit 9a which acquires the data supplied from the media, that is, the content; a display preparation unit (tab row preparation unit) 9b which prepares a ‘display image’ to associate and display the types of the acquired content with the media; a selection comparison unit (tab row comparison unit) 9c which specifies the media or the content selected by a user based on user's operation to determine whether or not to change the ‘display image’ presently prepared by the display preparation unit 9b; a display instruction unit (tab row display switching unit) 9d which instructs the display of a new ‘display image’, when the ‘display image’ determined to be newly displayed by the selection comparison unit 9c is different from the ‘display image’ presently prepared by the display preparation unit 9b; and a reproduction unit 9e which outputs, as a “video signal”, the ‘display image’ prepared by the display preparation unit 9b so that an externally connected video display apparatus 101 can display the display image.

It is to be noted that in the main control block 9, as to the data acquisition unit 9a, the display preparation unit 9b, the selection comparison unit 9c, the display instruction unit 9d and the reproduction unit 9e, a function concerning the ‘display image’ to be displayed in the video display apparatus 101 in accordance with the user's operation and a corresponding processing mechanism are extracted and explained. Needless to say, the reproduction of the video and audio data or the still picture is shared by a data processing unit (digital signal processor [DSP]) 13. Moreover, a detailed processing method or a constitution required for the processing is well known, and hence detailed description thereof is omitted.

It is to be noted that the user's instruction (control instruction), that is, user's operation input to the main control block 9 is realized by either user's direct input to a user operation input unit 15 connected to the main control block 9 or a remote control input to a remote control reception unit 17 by a remote controller (remote control terminal) R. Moreover, the main control block 9 includes an on-screen display (OSD) unit (not shown), and outputs a selection screen or an operation screen corresponding to operation information (control input) input via the user operation input unit 15 or the remote control reception unit 17 to the video reproduction apparatus 101 connected to an output unit 19 so that the apparatus can display the screen.

The DSP 13 will not be described in detail. The DSP includes a video encoder unit, a video decoder unit, an audio encoder unit, an audio decoder unit and the like.

The DSP 13, under the control of the main control block 9, processes and reproduces, for example, information read from the optical disk of the DVD or CD standard loaded in the optical disk drive unit 3, that is, content such as the moving picture, the audio (voice) and the still picture. It is to be noted that this also applies to information stored in a memory card inserted in the card reader 5 and a storage unit inserted in the USB input port 7. Moreover, needless to say, the DSP 13 can reproduce even content of a stream type stored on the optical disk of the DVD standard loaded in the optical disk drive unit 3.

The moving picture, the audio, the still picture or the like processed by the DSP 13 is appropriately output to the video reproduction apparatus 101 connected to the output unit 19 via the output unit 19 under the control of the main control block 9. It is to be noted that in the video reproduction apparatus 101, a monitor apparatus which reproduces the video and a speaker apparatus which reproduces the voice (audio) may integrally be provided, and may independently be prepared. Moreover, needless to say, the video reproduction apparatus may be a combination of the monitor apparatus and an audiovisual (AV) amplification apparatus or the like.

The user operation input unit 15 accepts the operation input (from the user) directly instructed with an operation button group (not shown) provided in a main body of the information reproduction apparatus 1. For example, a reproduction instruction or the like with a reproduction (PLAY) button usually provided in the main body of the information reproduction apparatus 1 can be input by the user operation input unit 15.

The remote control reception unit 17 accepts control information instructed from the user via the remote controller R, for example, a start signal (control instruction) which selectively operates one of the optical disk drive unit 3, the card reader 5 and the USB input port 7 as selectable content suppliers. It is to be noted that when the optical disk drive unit 3 is selected, the apparatus is started as either a [DVD player] or a [CD player] described later in accordance with the type of the inserted disk.

It is to be noted that a communication unit 21 connectable to a network NT is prepared, whereby a server positioned on the network or another player apparatus may be regarded as the content supplier so that the content can be acquired. Moreover, the above elements may be realized by hardware or by software using a microcomputer (CPU) or the like.

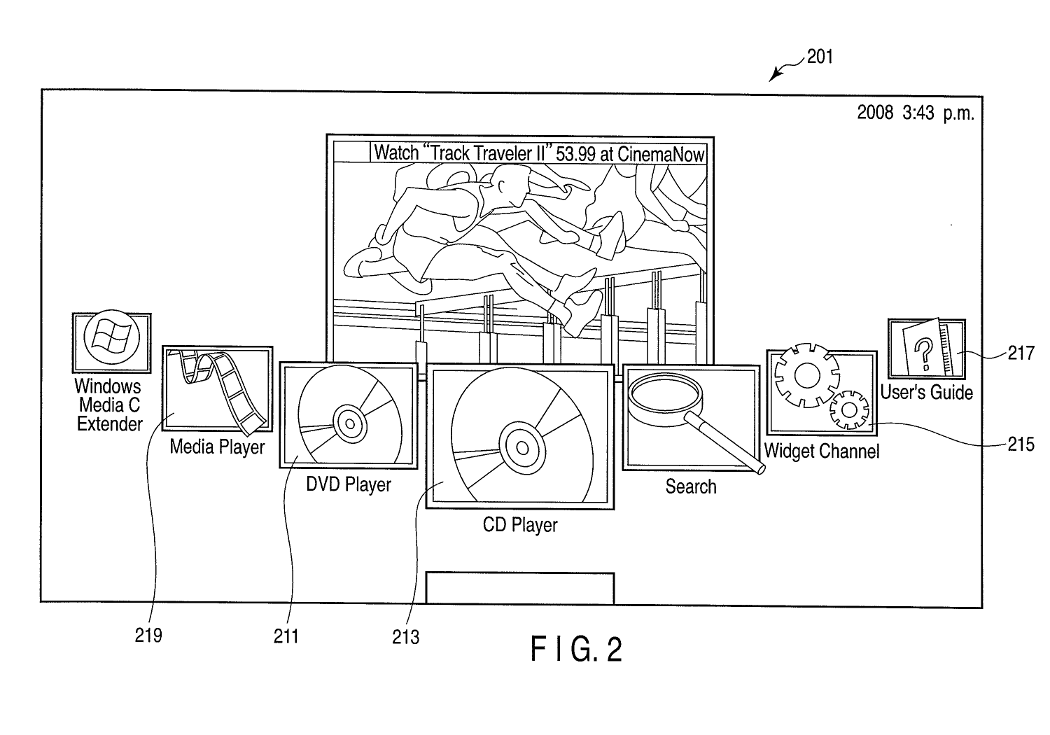

FIG. 2 shows an example of “the video signal” output to the video reproduction apparatus (monitor apparatus) at the start of the information reproduction apparatus schematically explained with reference to FIG. 1. It is to be noted that in the example shown in FIG. 2, for the sake of explanation, video actually displayed in the video reproduction apparatus is schematically shown, and (including a case where) the video is different from an original video signal.

When a power switch (main switch) (not shown) is turned on to end an initialization operation, a video signal is output to the monitor apparatus (video reproduction apparatus) 101 so that a “display” 201 referred to as the ‘start screen’ shown in the example of FIG. 2 can be displayed.

The “display” 201 includes a “display” 211 which can input a control signal for starting the [DVD player] capable of reproducing, for example, the video and voice, that is, the moving picture, or the still picture from the optical disk of the DVD standard; a “display” 213 which can input a control signal for starting, for example, the [CD player] capable of reproducing music (audio) or the voice of recitation or the like from the optical disk of the CD standard; a “display” 215 which can input a control signal for starting, for example, a widget; a “display” 217 which can input a control signal for starting a user's guide; a “display” 219 which can input a control signal for starting a [media player] which can directly reproduce the content of an arbitrary type from an arbitrary medium that can be reproduced by the information reproduction apparatus 1 and the like. It is to be noted that the respective “displays” 211, 213, . . . , and 219 are equivalent to “icons” broadly utilized in, for example, a personal computer (PC) or a portable terminal in a broad sense.

Positions where the “displays” 211, 213, . . . , and 219 corresponding to the respective functions or programs are displayed are arbitrarily set. It is to be noted that, needless to say, the displays are usually positioned at initial positions (default positions) beforehand prepared. Moreover, the positions where the “displays” 211, 213, . . . , and 219 are displayed can be moved to user's favorite positions, that is, positions designated by the user.

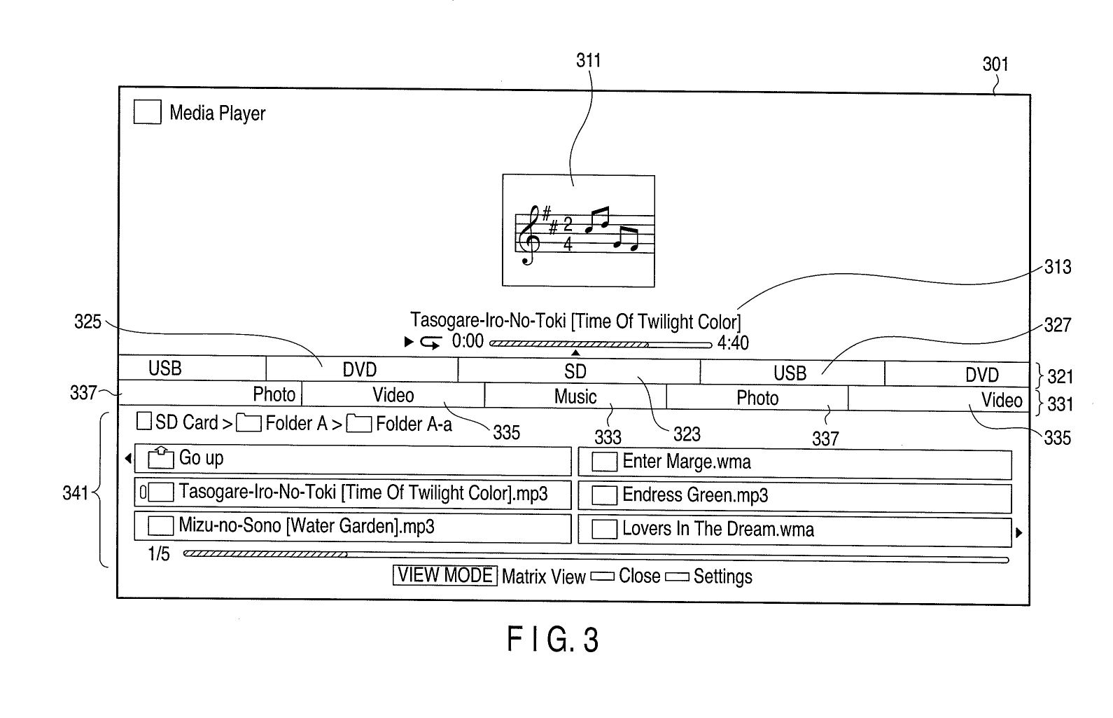

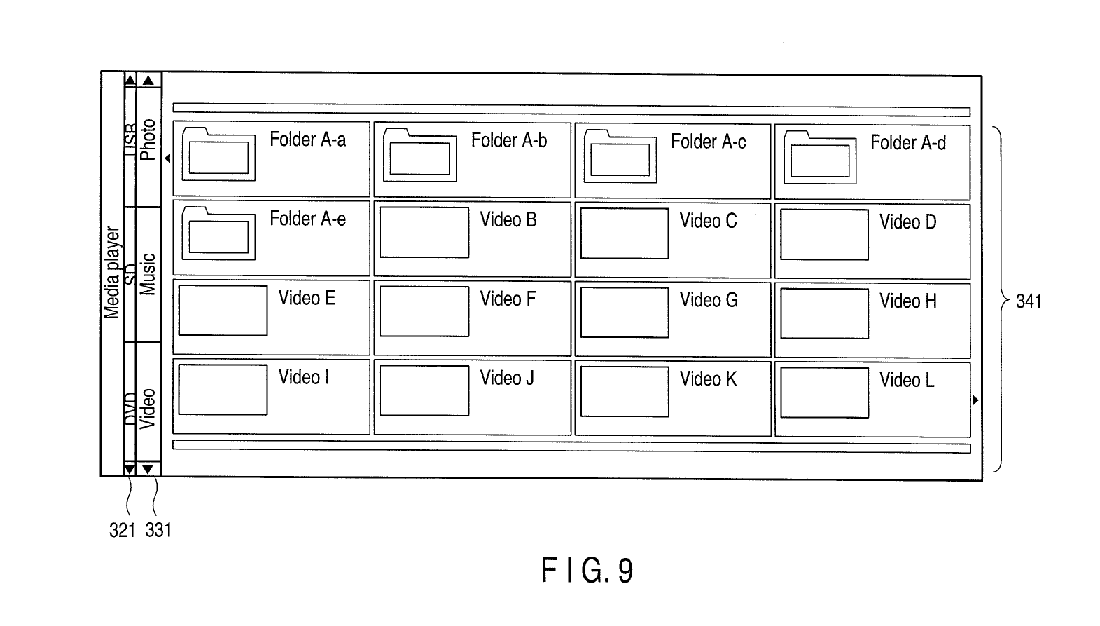

FIG. 3 shows an example of a screen display in a state in which a “display” for starting a media player function in the ‘start screen’ explained with reference to FIG. 2, and the [media player] is started. It is to be noted that the ‘start screen’ can be customized by the user (setting of the ‘start screen’ to reflect the user's preferences), and a list of reproducible content may be displayed as shown in one example of FIG. 9. It is to be noted that as to the example shown in FIG. 3, in the same manner as in the example shown in FIG. 2, for the sake of explanation, video actually displayed in the video reproduction apparatus is schematically shown, and (including a case where) the video is different from an original video signal.

In a main menu (non-customized (default) start screen in a case where the [media player] is started) of the [media player] shown in FIG. 3, there are displayed an “image display region” 311 for displaying a reproduced image in a case where the content which is being reproduced is the still picture or the moving picture; a “title display region” 313 for displaying a title given to the content which is being reproduced, for example, a program title in the case of the moving picture or the still picture, an individual title in the case of the still picture, a tune title in the case of music or the like; a “media type display region (first tab)” 321 for displaying the type of the supplier of the content which is being reproduced, that is, the medium in which the content is stored; a “content type display region (second tab)” 331 for displaying the type of the content which is being reproduced; and a “detailed information display region” 341 for displaying the individual file title of the content which is a reproduction target in accordance with the selected media type and content type. It is to be noted that the “detailed information display region” 341 also displays an alert display such as a ‘NO FILE’ display to report that any reproducible content (file) is not recorded or a ‘NO MEDIA’ display to report that the selected medium is not available, in accordance with the selected media type and content type.

The “media type display region (first tab)” 321 and the “content type display region (second tab)” 331 are displayed vertically in two rows substantially in the center of the screen display. When the region is focused via the remote control terminal R (i.e., when the remote control terminal (not shown) is operated to input the control signal for selecting one of the first tab 321 and the second tab 331 displayed in the screen), a visually recognizable “focus display” can be achieved by, for example, increasing luminance or changing color. It is to be noted that the “focus display” is switched to a selected tab side, every time the selected tab is changed by the remote control terminal R, that is, every time the “first tab” 321 and the “second tab” 331 are alternately selected. It is to be noted that the above focus can be realized by, for example, moving a cursor in a well known manner or selecting the position of the cursor.

On the other hand, in the “focus display” state, when the “first tab” 321, that is, the media type or the “second tab” 331, that is, the content type is selected by the remote control terminal R and a “display” of the tab, that is, one of a “DVD” display 325, an “SD” display 323 and a “USB” display 327 of the “first tab” 321 is selected, the “display” is moved substantially to the center of the screen display in a horizontal direction, and is further changed to a “highlight display” by increasing the luminance or the like. Similarly, when one of a “photo” display 337, a “video” display 335, and a “music” display 333 of the “second tab” 331 is selected, the “display” is moved substantially to the center of the screen display in the horizontal direction, and is further changed to the “highlight display” by increasing the luminance or the like.

It is to be noted that to select an arbitrary tab and an arbitrary content type or media type, after focusing by the remote control terminal R, a [determine (or OK)] button (not shown) is turned on to output a corresponding control signal, thereby changing the screen display. Moreover, a specific tab, that is, one of the “first tab” 321 and the “second tab” 331 is substantially selected also by the operation of selecting and determining one of the arbitrary displays in the tab, that is, one of the “DVD” display 325, the “SD” display 323, the “USB” display 327, the “photo” display 337, the “video” display 335, and the “music” display 333. That is, with the operation of the remote control terminal R for selecting one of the “DVD” display 325, the “SD” display 323, the “USB” display 327, the “photo” display 337, the “video” display 335, the “music” display 333 and the all display 339, the “first tab” 321 and the “second tab” 331 are automatically changed (selected).

Therefore, when the media type in the “first tab” 321 or the content type in the “second tab” 331 is selected with the operation of the remote control terminal R, the display of the selected media type or content type is moved to the center of the tab.

It is to be noted that mutual switching between the “first tab” 321 and the “second tab” 331, that is, the movement to the tab positioned on the upside (with respect to the presently selected (focused) tab) as defined by [↑ (an up arrow)] or the movement of the tab to the downside (with respect to the presently selected (focused) tab) as defined by [↓ (down arrow)] can easily be switched only by one of operations shown by [↑ (up arrow)] and [↓ (down arrow)].

It is to be noted that the switching of the “display” along the horizontal direction in the arbitrary tab is controlled so that only one display moves in order along the horizontal direction in the tab to which the display belongs (in which the display is disposed), every time the remote control terminal R is operated as shown by a [left arrow] or a [right arrow] (control instruction is input). In consequence, visibility from the user improves.

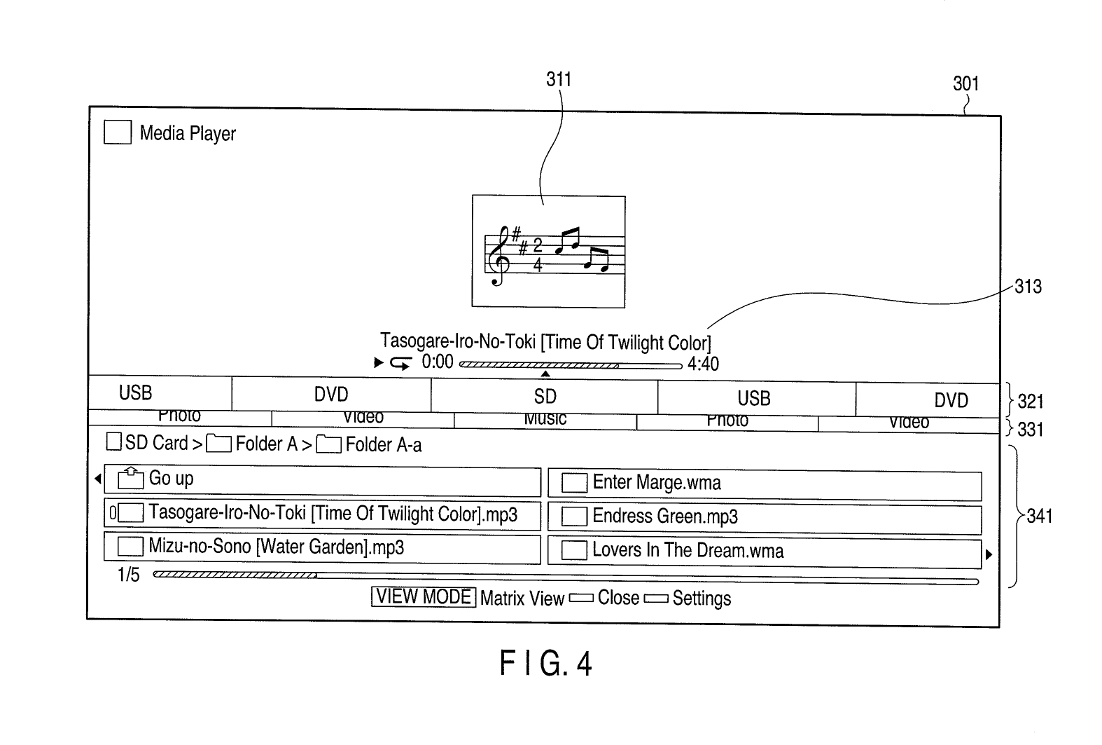

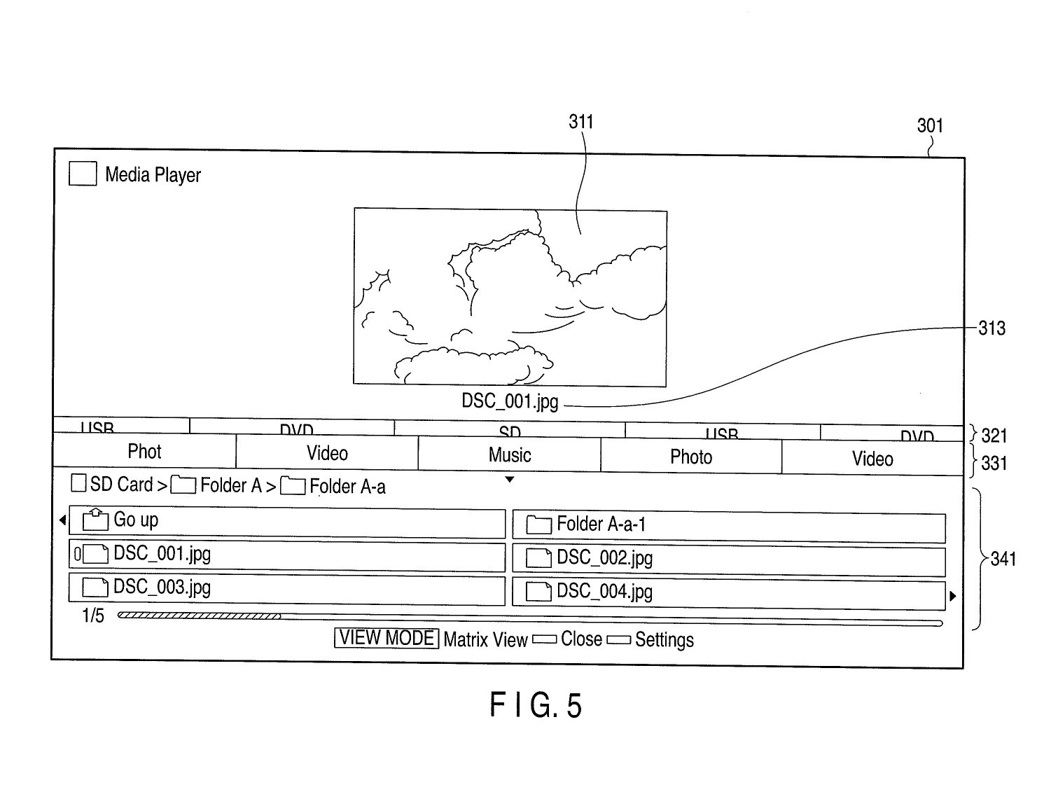

FIGS. 4 and 5 show a (screen) display example for explaining a relation between the transition (change) of the screen display and the input of the control signal by the operation of the remote control terminal in a case where the arbitrary content and medium are reproduced by using the first and second tabs in the [media player] function explained with reference to FIG. 3.

FIG. 4 shows a state in which the type of the medium where the content to be reproduced by the user is stored is designated via a “first tab (media type display region)” in the main menu of the [media player] shown in FIG. 3.

When the first tab 321 is focused by the operation of the remote control terminal R by the user, the first tab 321 is enlarged in the vertical direction of the display screen. At this time, a display configuration is changed so that the first tab 321 is positioned in a front surface with respect to the second tab 331. That is, a display method is visually and visibly changed so that the first tab 321 is positioned on the upper surface of the second tab 331 (above the second tab 331) in planar view.

Therefore, visibility for the user who focuses the first tab 321 to select the medium by using the first tab 321 improves. In consequence, the occurrence of an operation error decreases, and convenience for the user improves.

FIG. 5 shows a state in which the type of the content to be reproduced by the user is designated via a “second tab (content type display region)” in the main menu of the [media player] shown in FIG. 3.

When the second tab 331 is focused by the operation of the remote control terminal R by the user, the second tab 331 is enlarged in the vertical direction of the display screen. At this time, the display configuration is changed so that the second tab 331 is positioned in the front surface with respect to the first tab 321. That is, the display method is visually and visibly changed so that the second tab 331 is positioned on the upper surface with respect to the first tab 321 (above the first tab 321) in planar view.

Therefore, the visibility for the user who focuses the second tab 331 to select the content type by using the second tab 331 improves. In consequence, the occurrence of the operation mistake decreases, and the convenience for the user improves.

It is to be noted that the display configuration (display method) of the first or second tab shown in FIG. 4 or 5 is changed, that is, the selected (focused) tab is enlarged and displayed in the front surface in the same manner as in the case of the transition from the start screen shown in FIG. 3, even in a case where the remaining tab is selected from the state in which each tab is selected as explained with reference to FIGS. 4 and 5.

That is, in a case where the second tab 331 is focused to set the content type in a state in which, for example, the [SD] has been selected as the media type by the first tab 321 as shown in FIG. 4, as shown in FIG. 5, the display is changed so that the second tab 331 is seen on the side of the front surface and so that the width of the second tab 331 increases with respect to the first tab 321 which has been displayed in the width larger than that of the second tab 331 and visibly on the side of the front surface as compared with the second tab 331. Needless to say, in a case where the focus is moved to the first tab 321 from a state in which the second tab 331 is focused as shown in FIG. 5, the display of the first tab 321 is changed as shown in FIG. 4.

It is to be noted that the change of the display system of the tabs explained with reference to FIGS. 4 and 5 can similarly be applied to a system (screen display) in which three or more tabs are used, and the display system is changed so that the focused tab is positioned in the foremost surface.

In this way, the visual display is applied to two or more closely displayed tabs so that the selected tab is seen on the side of the front surface (an upper layer), whereby it can visually clearly be recognized that one of the first layer and a second layer (any of three or more layers) is selected.

Moreover, the visual display is applied to the first and second layers (layers selected from three or more layers) so that the selected tab is enlarged and seen on the side of the front surface (upper layer), whereby it is possible to display a selected state (selection path) indicating the layer from which the presently selected layer is selected in order.

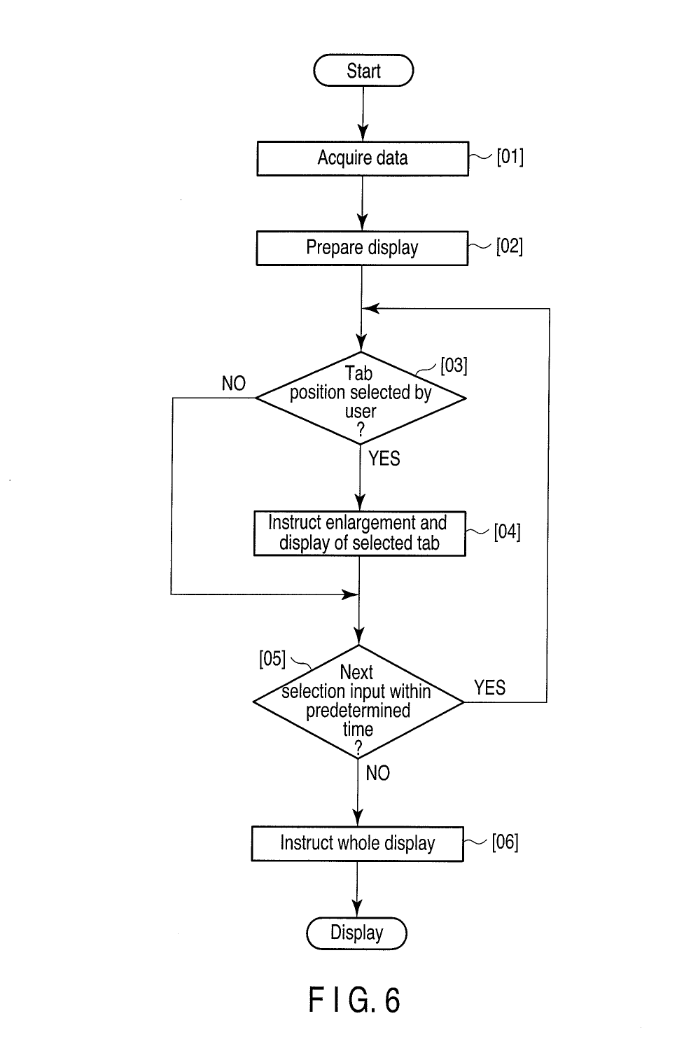

FIG. 6 is a schematic flowchart for explaining, in a software manner, a function of changing the display system of the first and second tabs explained with reference to FIGS. 4 and 5.

When the ‘start screen’ shown in FIG. 2 is displayed, an initializing operation is completed and then the media player function is selected, information indicating the presence/absence of an information reproducible medium to be displayed as the [media type] in the first tab of the [media player] function screen explained with reference to FIG. 3, the allowing/prohibiting of the reading of data from each medium and the types and number of content items stored in each medium, that is, data necessary for the operation of the [media player] is acquired [01] of block.

Subsequently, “display data” for displaying the start screen of the [media player] shown in FIG. 3 is prepared based on the acquired data, and output to the video display apparatus 101 via the output unit 19 shown in FIG. 1, in block [02].

Next, when a control instruction to change the tab, that is, an instruction to switch the first and second tabs is input by the user (when the tab to be focused is selected) [03-YES] of block, the change of the width of the selected tab is instructed. That is, the width of the tab is increased to enlarge and display the selected tab, and the (selected) tab is enlarged and displayed so that it can visually be recognized that the tab is positioned in the front surface as compared with the remaining tabs [04] of block.

After changing the display of the tab in block [04], the presence/absence of the input of the subsequent instruction to change the display of the tab is detected for a constant period of time [05] of block. When there is no input of the subsequent instruction for the change [05-NO] of block, the screen in which the width of one of the tabs is enlarged is displayed as explained with reference to FIGS. 4 and 5 (whole display), in block [06].

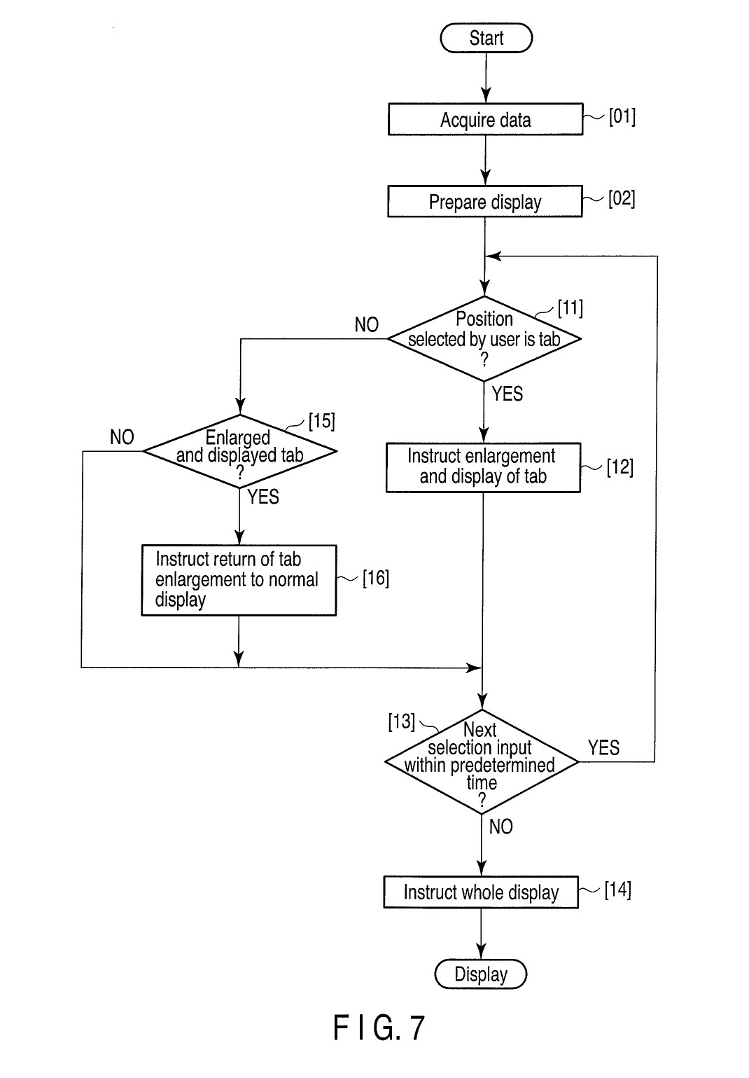

FIG. 7 is a schematic flowchart for explaining, in a software manner, another embodiment of the method for changing the display explained with reference to FIG. 6.

When the ‘start screen’ shown in FIG. 2 is displayed, an initializing operation is completed and then the media player function is selected, information indicating the presence/absence of an information reproducible medium to be displayed as the [media type] in the first tab of the [media player] function screen explained with reference to FIG. 3, the allowing/prohibiting of the reading of data from each medium and the types and number of content items stored in each medium, that is, data necessary for the operation of the [media player] is acquired [01] of block.

Subsequently, “display data” for displaying the start screen of the [media player] shown in FIG. 3 is prepared based on the acquired data, and output to the video display apparatus 101 via the output unit 19 shown in FIG. 1, in block [02].

Next, it is checked by the user whether a focused target is the selection (change) of the tab or the movement to the target other than the tab [11] of block.

When the selection (change) of the tab is instructed in of block [11], ([11-YES] of block), the change of the width of the selected tab is instructed. That is, the width of the tab is increased to enlarge and display the selected tab, and the selected tab is enlarged and displayed so that it can visually be recognized that the tab is positioned in the front surface as compared with the remaining tabs [12] of block.

It is to be noted that after changing the display of the tab in block [12], the presence/absence of the input of the subsequent instruction to change the display of the tab is detected for a constant period of time [13] of block. When there is no input of the subsequent instruction for the change [13-NO] of block, the screen in which the width of one of the tabs is enlarged is displayed as explained with reference to FIG. 4 or 5 (whole display), in block [14].

On the other hand, when the movement to the target other than the tab is instructed in block [11], ([11-NO] of block), it is checked whether or not the tab has been enlarged and displayed before [15] of block. When the enlargement of the tab is not selected [15-NO] of block, the presence/absence of the input of the subsequent instruction (presence/absence of selection of tab) is detected for the constant period of time [13] of block.

On the other hand, when the movement to the target other than the tab is instructed in block [11], ([11-NO] of block), and it is detected that the tab has been enlarged and displayed before [15-YES] of block, the enlarged tab is returned to its original display [16] of block. Afterward, the presence/absence of the input of the subsequent instruction (presence/absence of selection of tab) is detected for the constant time period [13] of block.

That is, in a case where no tab is selected, the display of the target other than the tab, for example, “list display”, or “button display” used for directly starting an arbitrary function is directly selected, and the tab has been enlarged and displayed, the display of the tab is returned to its original size. This prevents the tab from being emphasized or prevents the “list display” or “button display” for the direct instruction from becoming inconspicuous, whereby influence on operability can be suppressed.

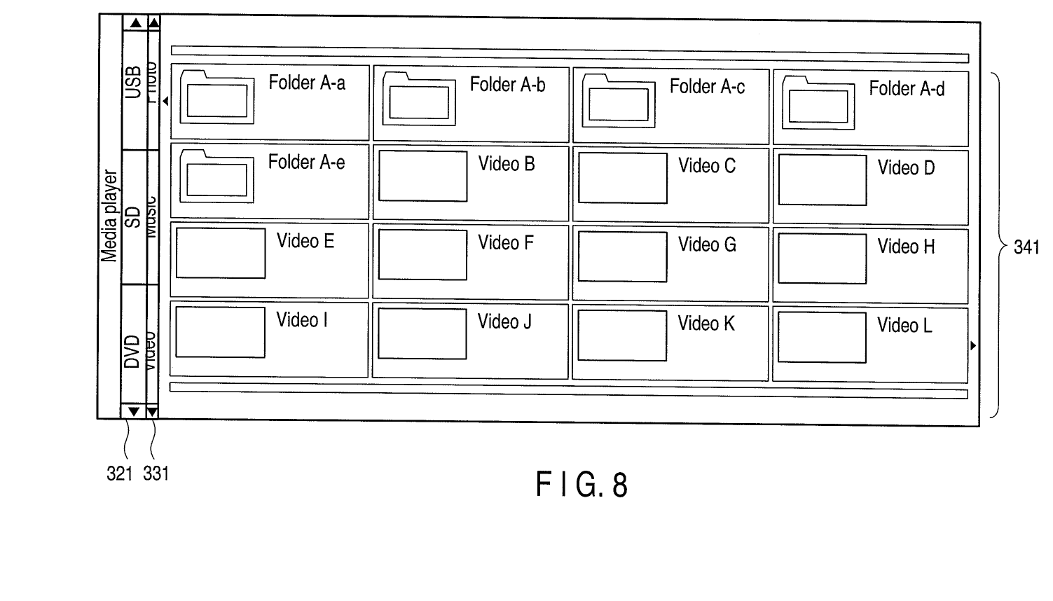

It is to be noted that an example of the enlargement of the tab display explained with reference to FIGS. 4 and 5, and FIG. 3 (change of display of selected tab) is shown in FIGS. 8 and 9. The enlargement can be realized even in a display screen having a different direction.

That is, a display example 1301 shown in FIG. 8 indicates a state in which the type of the medium where the content to be reproduced by the user is stored is designated via a “first tab (media type display region)” 1321. When the first tab 1321 is focused, the first tab 1321 is enlarged in the horizontal direction of a display screen. At this time, a display configuration is changed so that the first tab 1321 is positioned in the front surface with respect to a second tab 1331. That is, a display method is visually and visibly changed so that the first tab 1321 is positioned in an upper surface with respect to the second tab 1331 (above the second tab 1331) in planar view.

Similarly, a display example 1301 shown in FIG. 9 indicates a state in which the type of the content to be reproduced by the user is designated via a “second tab (content type display region)” 1331. When the first tab 1331 is focused, the second tab 1331 is enlarged in the horizontal direction of a display screen. At this time, a display configuration is changed so that the second tab 1331 is positioned in the front surface with respect to a first tab 1321.

As described above, the embodiment is applied to constitute a hierarchical structure by grouping the types of content applied to reproducible contents and the types of media in which the content is stored in accordance with the content type and the media type, whereby the content type and media type included in each hierarchy are independently displayed. Moreover, the display of the hierarchy selected for the reproduction is emphasized on the side of the front surface as compared with the display of the remaining hierarchies, whereby operability for the input of a control instruction as a reproduction instruction improves.

Moreover, when the display of the hierarchy selected for the reproduction is emphasized on the side of the front surface as compared with the display of the remaining hierarchies, it is possible to display a selected state indicating the layer from which the presently selected layer is selected in order (layer selected later is enlarged and displayed). In consequence, a functional display is obtained so that it is possible to easily understand a selection path until the presently selected content or medium is selected.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information reproduction apparatus comprising:
a first display region configured to display types of media;
a second display region configured to display types of content in the media; and
a display controller configured to display a selected one of the first display region and the second display region with emphasis, when the selection is made.

2. The information reproduction apparatus of claim 1, wherein the first display region comprises a plurality of media display areas configured to identify reproducible media, and wherein a media display area selected from media display areas is configured to move to the center of the first display region in a longitudinal direction.

3. The information reproduction apparatus of claim 1, wherein the second display region comprises a plurality of content display areas configured to identify reproducible content types, and wherein a content display area selected from content display areas is configured to move to the center of the second display region in the longitudinal direction.

4. The information reproduction apparatus of claim 1, further comprising:
a signal output module configured to output an image display signal output from the display controller as a video signal.

5. The information reproduction apparatus of claim 1, wherein the display with emphasis in the first display region and the second display region comprises the selected display region being wider than the display region which is not selected.

6. The information reproduction apparatus of claim 5, wherein the width of the display with emphasis is increased in the selected display region.

7. The information reproduction apparatus of claim 1, wherein the display with emphasis in the first display region and the second display region comprises the selected display region being visibly displayed over the display region which is not selected.

8. The information reproduction apparatus of claim 7, wherein the whole selected display region is displayed with emphasis.

9. An information reproduction method comprising:
extracting a type of a reproducible medium and a type of a reproducible content;
displaying the extracted medium type in a first display region;
displaying the extracted content type in a second display region; and
displaying a selected display region with emphasis in contrast to the display region which is not selected, of the first and second display regions, in response to the selection.

10. The information reproduction method of claim 9, wherein displaying with emphasis comprises setting the width of the selected region being larger than the width of the display region which is not selected.

11. The information reproduction method of claim 9, wherein displaying with emphasis comprises visibly displaying the selected region over the display region which is not selected.
